(19) United States
(12) Patent Application Publication
(10) Pub. No.: US 2026/0322117 A1
(43) Pub. Date: Oct. 15, 2026

(54) POWER CONDITIONER AND FREQUENCY CONTROL METHOD

(71) Applicant: TMEIC CORPORATION, Tokyo (JP)

(72) Inventor: Mohammad BANI SHAMSEH, Tokyo (JP)

(73) Assignee: TMEIC CORPORATION, Tokyo (JP)

(21) Appl. No.: 19/117,122

(22) PCT Filed: Sep. 15, 2023
(86) PCT No.: PCT/JP2023/033746

§ 371 Date: Mar. 31, 2025

(51) Int. Cl. H02J 3/0014; H02M 1/00; H02M 1/32; H02M 7/539

(52) U.S. Cl. CPC H02J 3/00142; H02M 1/0025; H02M 1/32; H02M 7/539

(57) ABSTRACT

A power conditioner includes an inverter that converts DC power output from a battery into AC power and supplies the AC power to a power grid and a controller that controls the inverter. The controller calculates a frequency change amount of the AC power based on differential power that is a difference between the AC power and target power. The controller calculates a correction amount for correcting the frequency change amount to be smaller than a threshold. Further, the controller sets, as a target frequency, a frequency obtained by adding a rated frequency of the inverter to a difference between the frequency change amount and the correction amount. Furthermore, the controller instructs the inverter to bring a frequency of the AC power close to the target frequency.

### TECHNICAL FIELD

The present disclosure relates to a technique for controlling the frequency of a power conditioner.

### BACKGROUND ART

Patent Literature 1 discloses a power grid stabilization system that stabilizes a power grid. Specifically, the power grid stabilization system calculates frequency change rates of generators at the time of an assumed accident. The power grid stabilization system calculates a range up to a stabilization limit of a frequency change rate based on the generator having the largest frequency change rate. Further, the power grid stabilization system calculates an amount of change of effective power of a power converter based on the range up to the stabilization limit of the frequency change rate and registers the amount of change in a database. This makes it possible to achieve stabilization at the time of an actual accident by, when the assumed accident actually occurs, executing stabilization measures decided beforehand.

### CITATION LIST

### Patent Literature

[PTL 1] JP 2023060571 A

### SUMMARY OF THE INVENTION

### Problems to be Solved by the Invention

A case in which the frequency of AC power output from a power conditioner (specifically, an inverter) has decreased because of occurrence of a system accident of a power grid is considered. In this case, the AC power is assumed to rise according to the decrease in the frequency of the AC power and exceed rated power of the inverter. Further, because of characteristics of the inverter, a ratio of an output voltage of the inverter and the frequency is controlled to be constant. For example, when the frequency of the AC power decreases, the output voltage of the inverter also decreases according to the characteristics of the inverter. On the other hand, since the AC power rises, an output current of the inverter falls into an overcurrent state.

According to Patent Literature 1, when the frequency of the AC power output from the inverter has fluctuated, control for stabilizing the AC power is performed. However, since the frequency keeps the decreased state, it is likely that the output voltage of the inverter is also in a low state and the output current of the inverter falls into the overcurrent state.

One object of the present disclosure is to provide a technique that, when the frequency of AC power output from an inverter has fluctuated, can prevent an output current of the inverter from falling into an overcurrent state.

### Means for Solving the Problems

A first aspect of the present disclosure relates to a power conditioner. The power conditioner includes: an inverter that converts DC power output from a battery into AC power and supplies the AC power to a power grid; and a controller that controls the inverter. The controller calculates a frequency change amount of the AC power based on differential power that is a difference between the AC power and target power. The controller calculates a correction amount for correcting the frequency change amount to be smaller than a threshold. Further, the controller sets, as a target frequency, a frequency obtained by adding a rated frequency of the inverter to a difference between the frequency change amount and the correction amount. Furthermore, the controller instructs the inverter to bring a frequency of the AC power close to the target frequency.

A second aspect of the present disclosure relate to a frequency control method. The frequency control method includes: converting DC power output from a battery into AC power using an inverter and supplying the AC power to a power grid; calculating a frequency change amount of the AC power based on differential power that is a difference between the AC power and target power; calculating a correction amount for correcting the frequency change amount to be smaller than a threshold; setting, as a target frequency, a frequency obtained by adding a rated frequency of the inverter to a difference between the frequency change amount and the correction amount; and instructing the inverter to bring a frequency of the AC power close to the target frequency.

### Advantageous Effects of the Invention

According to the present disclosure, the frequency change amount of the AC power is calculated based on the differential power that is the difference between the AC power and the target power. Then, the correction amount for correcting the frequency change amount to be smaller than the threshold is calculated. Further, the frequency obtained by adding the rated frequency of the inverter to the difference between the frequency change amount and the correction amount is set as the target frequency. The inverter is instructed to bring the frequency of the AC power to close to the target frequency. Accordingly, when the frequency of the AC power output from the inverter has fluctuated, the frequency of the AC power is corrected and the AC power is also corrected to reduce the differential power. Therefore, it is possible to prevent an output current output from the inverter from falling into an overcurrent state and stabilize the power grid.

### BRIEF DESCRIPTION OF THE DRAWINGS

FIG. 1 is a diagram for explaining an overview of a power conversion system.

FIG. 2 is an explanatory diagram illustrating a specific example of a controller according to an embodiment.

FIG. 3 is an explanatory diagram illustrating a specific example of the controller according to the embodiment.

FIG. 4 is a flowchart illustrating a processing example of the controller according to the embodiment.

FIG. 5 is an explanatory diagram illustrating an output result example of an inverter according to the embodiment.

### DESCRIPTION OF EMBODIMENT

A power conditioner and a frequency control method according to an embodiment of the present disclosure are described with reference to the accompanying drawings. The same reference numerals and signs are added to elements common to the figures and redundant description of the elements is omitted.

### 1. Overview of a Power Conversion System

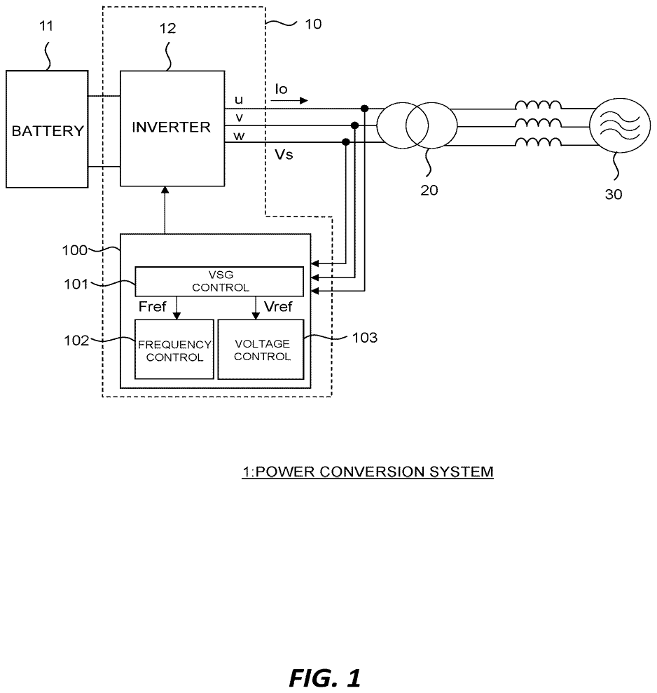

FIG. 1 is a diagram for explaining an overview of a power conversion system 1. The power conversion system 1 includes a battery 11, a power conditioner 10, a transformer 20, and a power grid 30. The power conditioner 10 includes an inverter 12 and a controller 100.

The battery 11 is a power storage device that stores electricity generated by renewable energy. Examples of the renewable energy include solar power, wind power, and water power.

The inverter 12 is a device that converts DC power output from the battery 11 into AC power and supplies the AC power to the power grid 30 via the transformer 20. Examples of the inverter 12 include a GFM inverter of a voltage control type.

The controller 100 is connected to the inverter 12 and controls the inverter 12. An output voltage Vs and an output current Io output from the inverter 12 are input to the controller 100. The controller 100 calculates, based on the output voltage Vs and the output current Io, AC power to be output from the inverter 12.

Note that the output voltage Vs and the output current Io input to the controller 100 are a detection value of the output voltage Vs (hereinafter referred to as Vs detection value) and a detection value of the output current Io (hereinafter referred to as Io detection value). The Vs detection value and the Io detection value are detected by a detector (not shown) provided between the power conditioner 10 and the power grid 30. In an example illustrated in FIG. 1, the Vs detection value and the Io detection value are detected between the power conditioner 10 and the transformer 20. However, the Vs detection value and the Io detection value may not be limited to this. The Vs detection value and the Io detection value may be detected, for example, between the transformer 20 and the power grid 30.

The output voltage Vs output from the inverter 12 consists of three phase voltages (Vsu, Vsv, and Vsw). The output current Io output from the inverter 12 consists of three phase currents (Iou, Iov, and Iow). That is, the Vs detection value described above includes a Vsu detection value, a Vsv detection value, and a Vsw detection value. The Io detection value described above includes an Iou detection value, an Iov detection value, and an low detection value.

The controller 100 executes VSG (Virtual Synchronous Generator) control 101 based on the Vs detection value and the Io detection value input to the controller 100. VSG means a virtual synchronous generator that simulatively imparts dynamic characteristics of a synchronous generator to the inverter 12. That is, the VSG control 101 means controlling the virtual synchronous generator. Parameters indicating the dynamic characteristics of the synchronous generator are used for the VSG control 101. Examples of the parameters include an inertia constant M and a braking constant D.

The controller 100 performs, based on a target frequency Fref obtained by the VSG control 101, frequency control 102 for controlling the frequency of AC power (consisting of the output voltage Vs and the output current Io) output from the inverter 12. Specifically, in the frequency control 102, the controller 100 instructs the inverter 12 to bring the frequency of the AC power close to the target frequency Fref. Details about a calculation example of the target frequency Fref are described below.

Accordingly, even when the frequency has fluctuated because of a system accident, the inverter 12 can output AC power of a stable frequency. Therefore, it is possible to continue operation of the inverter 12 and prevent the power grid 30 from becoming unstable. Note that function requirements for continuing the operation of the inverter are decided not to parallel off the power grid 30 all at once. The function requirements are referred to as FRT (Fault Ride Through) requirements. Examples of the FRT requirements are that the frequency of AC power is within a specified range and that a change rate of the frequency of the AC power is equal to or smaller than a reference value. According to this embodiment, the frequency of the AC power is controlled under the FRT requirements. For example, when the frequency of the AC power is decreasing and a power value of the AC power is rising, the frequency of the AC power is controlled.

Further, the controller 100 may perform, based on a target voltage Vref obtained by the VSG control, voltage control 103 for controlling the output voltage Vs output from the inverter 12. For example, when voltage drop of an AC voltage of the power grid 30 is equal to or larger than a predetermined value because of fluctuation in the AC voltage, the controller 100 instructs the inverter 12 to bring the output voltage Vs close to the target voltage Vref. Accordingly, even when LVRT (Low Voltage Ride Through) has occurred together with the fluctuation in the frequency, the inverter 12 can output a stable voltage. Therefore, it is possible to prevent the power grid 30 from becoming unstable.

### 2. Example of the Controller

### 2-1. Configuration Example

The controller 100 includes hardware for implementing various functions. The hardware may be a processing circuit or may be a computer that executes, with a CPU, a program stored in a storage device. Examples of the processing circuit include an FPGA (Field Programmable Gate Array) and an ASIC (Application Specific Integrated Circuit).

### 2-2. Calculation Example of the Target Frequency

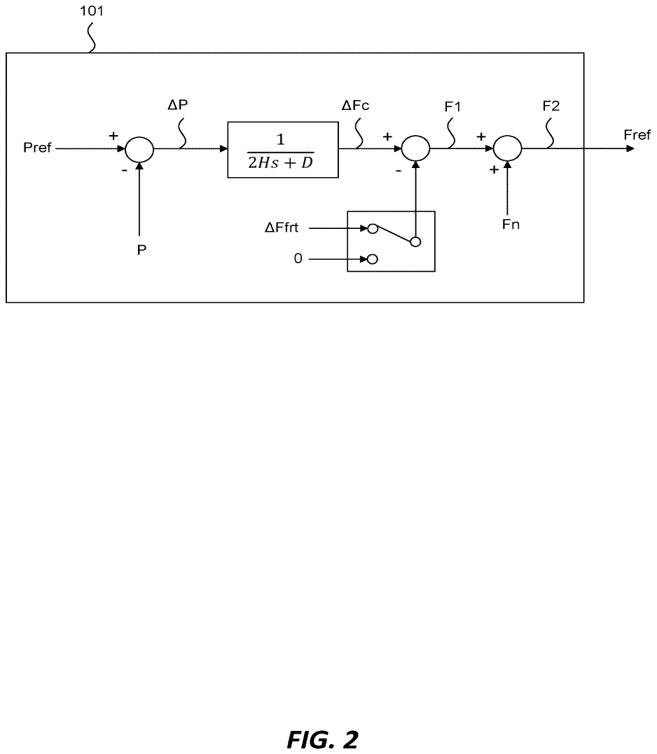

FIG. 2 is an explanatory diagram illustrating a specific example of a function of the controller 100 according to the embodiment. FIG. 2 illustrates a calculation example of the target frequency Fref in the VSG control 101. Specifically, in the VSG control 101, the controller 100 calculates, as differential power ΔP, the difference between the AC power P output from the inverter 12 and the target power Pref. However, the target frequency Fref calculated in the example illustrated in FIG. 2 is a value made dimensionless based on a rated frequency. Values made dimensionless are used for the target power Pref and the AC power P. For example, rated power is used for making these kinds of power dimensionless. That is, values at the time when the rated power is set to 1 are used as the values of the target power Pref and the AC power P in the calculation illustrated in FIG. 2.

Then, the controller 100 calculates a frequency change amount ΔFc of the AC power P based on the differential power ΔP. Specifically, the controller 100 sets, as a frequency change amount ΔFc, a frequency obtained by multiplying the differential power ΔP by parameters indicating dynamic characteristics of a synchronous generator. For example, when the dynamic characteristics are an inertia constant H, a braking constant D, and a unit time s, the frequency change amount ΔFc of the AC power P is represented by the following Expression (1).

$$[ Math . 1 ]$$

$$Δ F c = \frac{1}{2 Hs + D} \times Δ P \qquad ( 1 )$$

Further, the controller 100 calculates a correction amount ΔFfrt for correcting the frequency change amount ΔFc to be smaller than a threshold. Details of a calculation example of the correction amount ΔFfrt are described below.

Further, the controller 100 determines, based on predetermined conditions, whether it is necessary to correct the frequency change amount ΔFc. The predetermined conditions are that the frequency change amount ΔFc is larger than a predetermined value and the AC power P is larger than allowable overpower of the inverter 12, that is, maximum power allowed to be output exceeding rated power in a short period. The allowable overpower is set to, for example, 130% of the rated power. When the predetermined conditions are satisfied, the controller 100 determines that it is necessary to correct the frequency change amount ΔFc. In this case, the controller 100 subtracts the correction amount ΔFfrt from the frequency change amount ΔFc. On the other hand, when the predetermined conditions are not satisfied, the controller 100 determines that it is unnecessary to correct the frequency change amount ΔFc. In this case, the controller 100 does not subtract the correction amount ΔFfrt from the frequency change amount ΔFc. In the example illustrated in FIG. 2, when it is determined that it is unnecessary to correct the frequency change amount ΔFc, a value of a correction amount subtracted from the frequency change amount ΔFc is set to zero.

The controller 100 sets, as the target frequency Fref, a second frequency F2 obtained by adding a rated frequency Fn of the inverter 12 to a first frequency F1 obtained by subtracting the correction amount ΔFfrt from the frequency change amount ΔFc. The rated frequency Fn is a reference value in calculating the target frequency Fref made dimensionless as described above and is set to 1. A rated frequency before the target frequency Fref is made dimensionless is, for example, 50 Hz or 60 Hz.

### 2-3. Calculation Example of the Correction Amount of the Frequency Change Amount

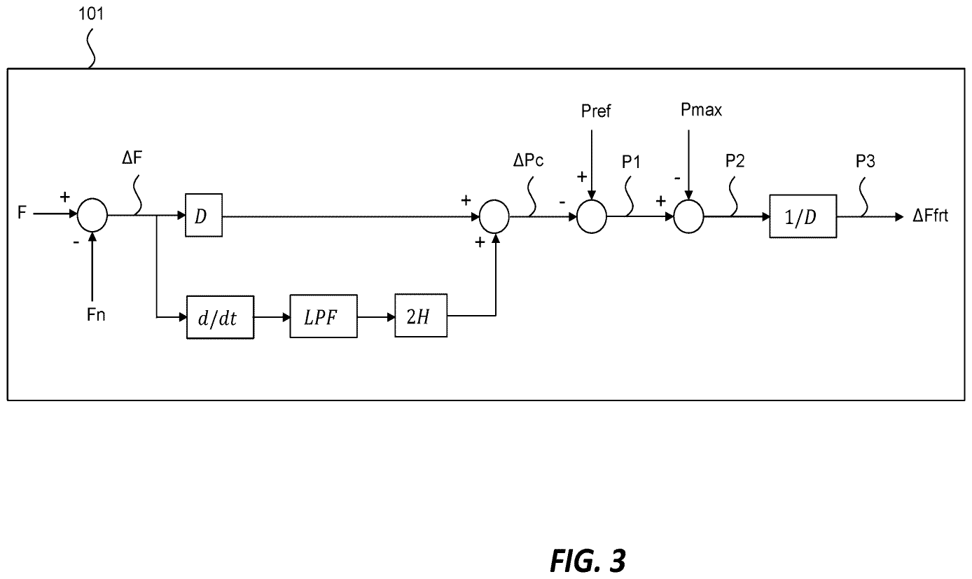

FIG. 3 is an explanatory diagram illustrating a specific example of the controller 100 according to the embodiment. FIG. 3 illustrates a calculation example of the correction amount ΔFfrt for correcting the frequency change amount ΔFc. Specifically, in the VSG control 101, the controller 100 calculates the difference between a frequency F of the AC power P and the rated frequency Fn as a differential frequency ΔF. As the frequency F, a value made dimensionless based on a measurement value of the frequency of the AC power P is used. The measurement value of the frequency of the AC power P is acquired, for example, via a PLL (Phase Locked Loop) provided in the controller 100. For example, in the case of a state in which the PLL is locked, the measurement value of the frequency of the AC power P and a reference frequency (an example: 50 Hz or 60 Hz) are not different. It can be confirmed that the frequency of the AC power P is in a state in which the frequency is not fluctuating. On the other hand, in the case of a state in which the PLL is unlocked, the measurement value of the frequency of the AC power P and the reference frequency are different. It can be confirmed that the frequency of the AC power P is fluctuating.

The controller 100 calculates a power change amount ΔPc of the AC power P based on the differential frequency ΔF. Specifically, the controller 100 sets, as the power change amount ΔPc, electric power obtained by multiplying the differential frequency ΔF by the parameters indicating the dynamic characteristics of the synchronous generator. For example, when the dynamic characteristics are the inertia constant H, the braking constant D, and the unit time s, the power change amount ΔPc of the AC power P is represented by the following Expression (2).

[Math. 2]

ΔPc=(2Hs+D)×ΔF (2)

The above Expression (2) is represented as the following Expression (3) or Expression (4) as well. Note that RoCoF (Rate of Change of Frequency) means a frequency change rate. A unit of RoCoF is represented by Hz/s.

$$[ Math . 3 ]$$

$$Δ Pc = 2 H \times \frac{d Δ F}{dt} + D \times Δ F \qquad ( 3 )$$

$$[ Math . 4 ]$$

$$Δ Pc = 2 H \times RoCoF + D \times Δ F \qquad ( 4 )$$

Further, first, the controller 100 subtracts the power change amount ΔPc from the target power Pref to obtain first power P1 and, then, subtracts allowable overpower Pmax of the inverter 12 from the first power P1 to obtain second power P2. For example, when the allowable overpower Pmax is set to 130% of the rated power, a value of the allowable overpower Pmax is 1.3. The controller 100 sets, as the correction amount ΔFfrt, third power P3 obtained by multiplying the second power P2 by a predetermined coefficient. The predetermined coefficient is represented by, for example, a formula (1/D) obtained by dividing 1 by the braking constant D.

### 2-4. Processing Example

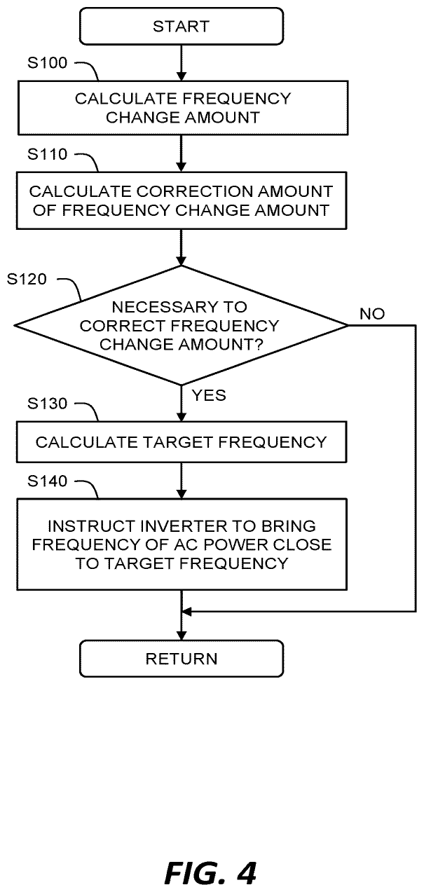

FIG. 4 is a flowchart summarily illustrating a processing example of the controller 100 according to the embodiment.

In step 100, the controller 100 calculates the frequency change amount ΔFc of the AC power P based on the differential power ΔP that is the difference between the AC power P and the target power Pref. Thereafter, the processing proceeds to step S110.

In step S110, the controller 100 calculates the correction amount ΔFfrt for correcting the frequency change amount ΔFc to be smaller than the threshold. Thereafter, the processing proceeds to step S120.

In step S120, the controller 100 determines, based on the predetermined conditions, whether it is necessary to correct the frequency change amount ΔFc. When it is determined that it is necessary to correct the frequency change amount ΔFc (step S120; Yes), the processing proceeds to step S130. Otherwise (step S120; No), the processing ends. The predetermined conditions are as described above.

In step S130, the controller 100 calculates the target frequency Fref. Specifically, the controller 100 sets, as the target frequency Fref, a frequency obtained by adding the rated frequency Fn of the inverter 12 to the difference between the frequency change amount ΔFc and the correction amount ΔFfrt. Thereafter, the processing proceeds to step S140.

In step S140, the controller 100 instructs the inverter 12 to bring the frequency of the AC power P close to the target frequency Fref.

### 4. Output Result Example of the Inverter

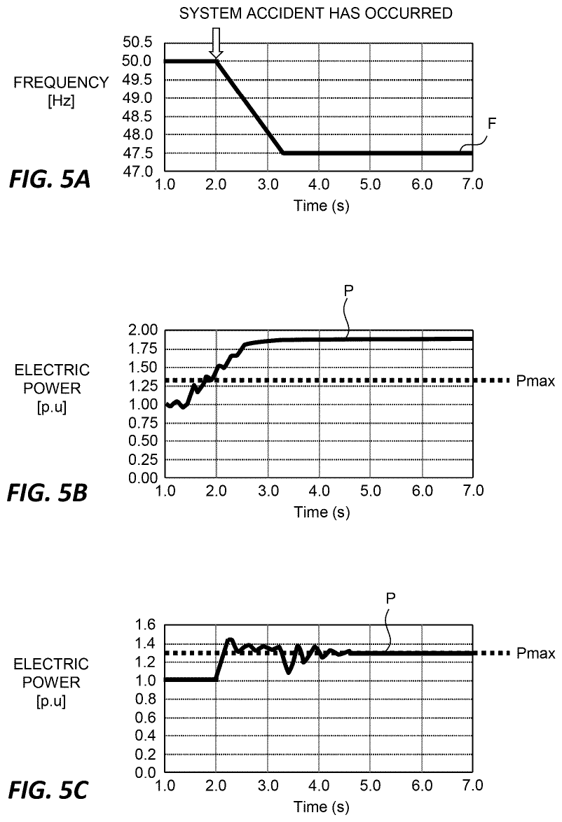

FIG. 5 is an explanatory diagram illustrating an output result example of the inverter 12 according to the embodiment. FIG. 5(A) illustrates an example of a waveform of the frequency F at the time when the frequency F of the AC power P has fluctuated. FIG. 5(B) illustrates an example of a waveform of the AC power P before the frequency F of the AC power P is corrected. FIG. 5(C) illustrates an example of a waveform of the AC power P after the frequency F of the AC power P has been corrected. Note that the vertical axis of graphs illustrated in FIG. 5(B) and FIG. 5(C) is represented by PU (Per Unit) but may be represented by percentage. In the examples illustrated in FIG. 5(B) and FIG. 5(C), the allowable overpower Pmax is represented as “1.3 PU”.

FIG. 5(A) illustrates an example in which a system accident has occurred at time 2.0 s. Thereafter, the frequency F decreases from 50 Hz to 47.5 Hz. In this case, the AC power P before the frequency F of the AC power P is corrected exceeds the allowable overpower Pmax as illustrated in FIG. 5(B). On the other hand, the AC power P after the frequency F of the AC power P has been corrected can be prevented from exceeding the allowable overpower Pmax as illustrated in FIG. 5(C).

As described above, when fluctuation in the frequency F of the AC power P (an example: a decrease in the frequency) has occurred at the time of system accident occurrence, the frequency F of the AC power P is corrected, whereby the AC power P is controlled not to exceed the allowable overpower Pmax. This makes it possible to prevent the output current Io output from the inverter 12 from becoming an overcurrent.

### 5. Effects

With the power conditioner 10 according to this embodiment, the frequency change amount ΔFc of the AC power P is calculated based on the differential power ΔP that is the difference between the AC power P and the target power Pref. Then, the correction amount ΔFfrt for correcting the frequency change amount ΔFc to be smaller than the threshold is calculated. Further, the frequency obtained by adding the rated frequency Fn of the inverter 12 to the difference between the frequency change amount ΔFc and the correction amount ΔFfrt is set as the target frequency Fref. The inverter 12 is instructed to bring the frequency F of the AC power P close to the target frequency Fref. Accordingly, when the frequency F of the AC power P has fluctuated, the frequency F of the AC power P is corrected and the AC power P is also corrected such that the differential power ΔP decreases. Therefore, it is possible to prevent the output current Io output from the inverter 12 from becoming an overcurrent and stabilize the power grid 30.

Reference Signs List

1 . . . Power conversion system, 10 . . . Power conditioner, 11 . . . Battery, 12 . . . Inverter,
20 . . . Transformer, 30 . . . Power grid, 100 . . . Controller, 101 . . . VSG control,
102 . . . Frequency control, 103 . . . Voltage control

1. A power conditioner comprising:
an inverter that converts DC power output from a battery into AC power and supplies the AC power to a power grid; and
circuitry that controls the inverter, wherein
the circuitry is configured to:
calculate a frequency change amount of the AC power based on differential power that is a difference between the AC power and target power;
calculate a correction amount for correcting the frequency change amount to be smaller than a threshold;
set, as a target frequency, a frequency obtained by adding a rated frequency of the inverter to a difference between the frequency change amount and the correction amount; and
instruct the inverter to bring a frequency of the AC power close to the target frequency.

2. The power conditioner according to claim 1, wherein
the circuitry is further configured to correct the frequency change amount when the frequency change amount is larger than a predetermined value and the AC power is larger than allowable overpower of the inverter.

3. The power conditioner according to claim 1, wherein
the circuitry is further configured to set, as the frequency change amount, a frequency obtained by multiplying the differential power by parameters indicating dynamic characteristics of a synchronous generator.

4. The power conditioner according to claim 1, wherein
the circuitry is further configured to:
calculate a power change amount of the AC power based on a differential frequency that is a difference between a measurement value of a frequency of the AC power and the rated frequency; and
set, as the correction amount, third power obtained by multiplying, by a predetermined coefficient, second power obtained by subtracting allowable overpower of the inverter from first power obtained by subtracting the power change amount from the target power.

5. The power conditioner according to claim 4, wherein
the circuitry is further configured to set, as the power change amount, electric power obtained by multiplying the differential frequency by parameters indicating dynamic characteristics of a synchronous generator.

6. The power conditioner according to claim 1, wherein
the circuitry is further configured to, when a volage drop of an output voltage is equal to or larger than a predetermined value because of fluctuation in an output voltage of the inverter, perform voltage control to bring the output voltage close to a target voltage.

7. A frequency control method comprising:
converting DC power output from a battery into AC power using an inverter and supplying the AC power to a power grid;
calculating a frequency change amount of the AC power based on differential power that is a difference between the AC power and target power;
calculating a correction amount for correcting the frequency change amount to be smaller than a threshold;
setting, as a target frequency, a frequency obtained by adding a rated frequency of the inverter to a difference between the frequency change amount and the correction amount; and
instructing the inverter to bring a frequency of the AC power close to the target frequency.
